(19) United States
(12) Patent Application Publication
(10) Pub. No.: US 2014/0351329 A1
(43) Pub. Date: Nov. 27, 2014

(54) METHOD AND SYSTEM FOR AUTOMATICALLY REPORTING AN EVENT FROM FILES RECEIVED ON A COMPUTER SERVER

(71) Applicant: François COLON, Marseille (FR)

(72) Inventor: François COLON, Marseille (FR)

(21) Appl. No.: 13/901,474

(22) Filed: May 23, 2013

(51) Int. Cl. H04L 29/08

(52) U.S. Cl. CPC H04L 67/06
USPC 709/204

(57) ABSTRACT

The invention relates to a method for automatically reporting an event based on files received on a computer server, the aforementioned method comprising:
acquiring, in digital file form, a photograph and/or video,
linking the acquired file with: a geo-location datum and a timestamp datum,
transferring the file and the linked geo-location and timestamp data to a remote computer server,
creating an analysis window that determines:
   a geographic zone defined around the place where the photograph and/or video was acquired,
   a temporal zone defined based on the time when the photograph and/or video was acquired,
acquiring other photograph and/or video digital files and linking them with geo-location and timestamp data, and then transferring these files and this data to the remote server,
analyzing the variation of the frequency of the number of files received by the remote server within the analysis window, in order to automatically report an event.

### TECHNICAL FIELD OF THE INVENTION

The invention relates to a method and system for automatically reporting an event based on files received on a computer server.

The invention relates to the general field of techniques of processing disparate data, in order to automatically define an event, that is to say, a significant fact or situation that is not normal (for example, performances, sports meetings, demonstrations, . . . ) and/or that triggers inhabitual usage behavior (for example: photographs or video taken) and/or that can be of interest to a community of users.

### PRIOR ART

When an event occurs (for example, a concert, a parade, a demonstration, a wedding, an accident . . . ), it is common, that multiple people acquire photographs and/or videos before sending them to contacts, or posting them on the Internet and in particular social networks such as Facebook®, Twitter®, Flickr®, etc.

When multiple people post in one place, and at the same time, photographs and/or videos related to an event, it can be advantageous to be able to automatically detect this event.

Known, from patent document WO2012/112449 (GOOGLE), is a technique enabling an automatic event recognition and a grouping of photographs. This technique comprises receiving, from a first user, first data image corresponding to a first photograph, receiving from a second user, second image data corresponding to a second photograph, comparing the first data image and the second image data, and determining that the first and second photographs correspond to a coincident event according to the comparison. This technique is thus based on a comparison of the features common to the two received photographs: photographs acquired at substantially the same time and/or substantially the same location and/or comprising identical visual elements, etc.

Although effective, this technique has certain disadvantages or limitations. First, the developed program is complex to implement, relative slowly to execute, potentially contains a high number of computer errors, and requires the mobilization of considerable computing resources in the server.

Furthermore, a comparison of photographs acquired at substantially the same time and/or at substantially the same location and/or comprising identical visual elements is not sufficient to consistently identify an event. Consider the case where each user acquires a photograph of the Eiffel Tower in Paris (France), at substantially the same time. Implementing the method disclosed in the patent document WO2012/112449, the server will deduce that this to be an event. While that is not the case, the Eiffel Tower being simply a much frequented tourist site in Paris (France) and does not as such constitute an event. The criteria used to define an event are therefore insufficient.

An objective of the invention is to remedy this state of affairs. In particular, an object of the invention is to offer an analysis technique based on parameters more reliable than a simple comparison, of features common, to received photographs.

Another object of the invention is to offer a technique enabling to more surely and more certainly recognize an event, with more relevance.

Another objective of the invention is to offer an analysis technique that is easier to develop and requires mobilizing less computer resources in the server.

### DISCLOSURE OF THE INVENTION

The solution offered by the invention is a method for automatically reporting an event based on file received on a computer server, the aforementioned method comprising:
acquiring, in digital file form, a photograph and/or video from a mobile terminal,
linking the acquired file with:
a geo-location datum in order to locate the place where the photograph and/or video was acquired,
a timestamp datum in order to link a date and time when the aforementioned photograph and/or the aforementioned video was acquired,
transferring the file and the linked geo-location and timestamp data to a remote computer server of the mobile terminal,
creating, in the remote server, an analysis window that determines:
a geographic zone defined around the place where the photograph and/or video was acquired, the aforementioned geographic zone defined by taking the geo-location data as reference,
a temporal zone defined based on the time the photograph and/or video was acquired, the aforementioned temporal zone being defined by taking the timestamp datum as reference,
acquiring other photograph and/or video digital files and linking them with geo-location and timestamp data, then transferring these files and this data to the remote server,
analyzing the variation of the frequency of the number of files received by the remote server within the analysis window, in order to automatically report an event.

The determination of an event here is based on an analysis of the frequency of the number of files received by the remote server, unlike the patent document WO2012/112449 in which only the features common to the photographs received were compared. It is now the “concentration” of files received within a geographic zone, and over a predetermined period, that is considered. In other words, in accordance with the invention, the activity of users per unit of time and of place is analyzed.

Returning to the case of the Eiffel Tower in Paris (France): this place being highly touristic, the server will normally receive between 100 photographs/hour and 200 photographs/hour, between 8:00 in the morning and 18:00 in the evening. If during this period, for example at 10:00 in the morning, the server receives 1000 photographs/hour, this frequency change will indicate with certainty that an event is taking place at this location.

Other notable steps of the method object of the invention are listed below, each of these steps able to be taken alone or in combination, independent of the notable steps defined above:
the analysis of the variation of the frequency, of the number of files received by the remote server within the analysis window, comprises the following succession of steps:
calculation of a mean frequency of the files received within the analysis window,
identification of a significant variation in the calculated mean frequency when the frequency of the files received within the analysis window varies from a predefined percentage relative to the aforementioned mean frequency.
the number of files previously sent by a user, to the remote server, and outside of the analysis window, can be a parameter taken into account for the identification of a significant variation from the mean frequency.
the number of previously sent to the remote file server, from a pre-localized geographic location, and outside the analysis window, can be a parameter taken into account for the identification of a significant change from the mean frequency.
the files emitted by a user who has a habit of having a high file transfer frequency can be discarded from the analysis, or assigned a weighting coefficient.
the step of automatic reporting of an event can comprise a step comprising linking a signature datum with all the files received within the analysis window, after and/or immediately before this event.
the step of automatic reporting of an event can comprise a step of comprising grouping, in an area of the remote server, all files the that are linked with the signature datum.
the step of automatic reporting of an event can comprise a notification step comprising generating, from the remote server, a notification signal and transmitting this signal to all the mobile terminals from which the files, received within the analysis window, are emitted.
the step of transferring files and linked geo-location and timestamp data, to the remote server, can be performed by means of a mobile computer program stored in the mobile terminals, wherein the program is downloaded to the aforementioned terminals further to a connection of the latter to an Internet server. In this case, the step of automatic reporting of an event can comprise a notification step comprising generating, from the remote server, a notification signal and transmitting this signal to all the mobile terminals in which the computer program is stored.
the step of automatic reporting of an event comprises a notification step comprising generating, from the remote server, a web page dedicated to the event, which page comprises an interface on which are viewable all the photographs and/or videos from the files received within analysis window, during the event. This page can comprise an area for rating or commenting on the aforementioned event and/or one or multiple areas for rating or commenting on each viewable photograph and/or video.
complementing the geo-location and timestamp data linked with the photograph and/or video files, commentary data can also be linked with the aforementioned files.

Another aspect of the invention relates to a system for automatically reporting an event based on files received on a computer server, the aforementioned system comprising:
mobile devices incorporating:
a means for acquiring, in digital file form, a photograph and/or a video,
a computer program comprising instructions to generate a geo-location datum in order to locate the place where the photograph and/or video was acquired, and to generate a timestamp datum in order to link a date and time when the aforementioned photograph and/or the aforementioned video was acquired,
a means for transferring the photographs and/or video file and the linked geo-location and timestamp data to a remote computer server of the mobile terminals,
the remote server incorporating a computer program comprising instructions for:
creating an analysis window that depends on:
on a geographic zone defined around the place where the first photograph and/or video was acquired, the aforementioned geographic zone being defined by taking as reference the geo-location datum linked with the aforementioned first photograph and/or video,
on a temporal zone defined based on the moment when the first photograph and/or video was acquired, the aforementioned temporal zone being defined by taking as reference the timestamp data linked with the aforementioned first photograph and/or video,
analyzing the variation of the frequency of the number of files received by the remote server within the analysis window, in order to automatically report an event.

### DESCRIPTION OF FIGURES

Other features and advantages of the invention will become more apparent upon reading the description of a preferred implementation mode will follow, with reference to the accompanying drawings, made by way of illustrative and non-limiting examples, and in which:

FIG. 1 shows schematically an example of a system in accordance with the invention,

FIG. 2 is a graph showing an example of analysis window, and on which geographic location data are plotted on the y-axis and time data are plotted on the x-axis,

FIG. 3 is a graph showing, for a given geographic location, an example of variation of the frequency of files received by the remote server (y-axis) as a function of time (x-axis),

FIG. 4 shows schematically an example of an internet page, dedicated to an event, adapted to be generated from the remote server.

### PREFERRED IMPLEMENTATION MODES OF THE INVENTION

The method object of the invention enables automatic reporting of an event. It is preferably applied to user communities, for example social communities such as Facebook®, Twitter®, FlickR®, instant messaging communities for example YAHOO or MSN®, etc. In acquiring photographs and/or videos, the members U1, U2, U3 in this community contribute to defining an event. And when an event is detected, each of the members of the community can be automatically alerted.

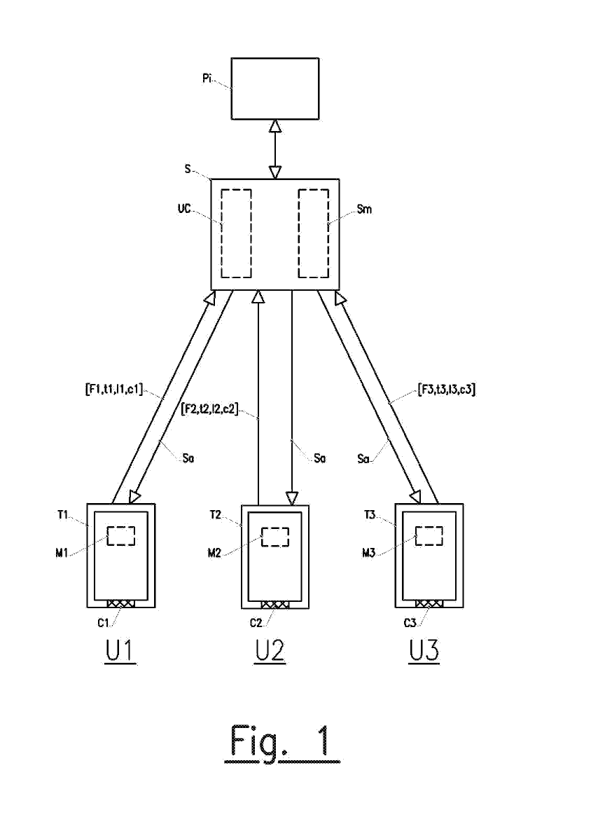

Referring to FIG. 1, a first user U1 who is situated at a given time and a given place, acquires, in form of digital file F1, a photograph and/or video (or media) from a mobile terminal T1. The latter, as well as the terminals T2 and T3 which are described later, are mobile phones, touch tablets, apparatus such as personal digital assistant (PDA), cameras, digital cameras, portable computers, or any other terminal equipped with an apparatus C1, C2, C3 to capture photograph and/or video capable recording a photograph and/or video in form of digital file. This digital file F1 (respectively F2, F3) can be stored in a memory M1 (respectively M2, M3) readable from the mobile terminal T1 (respectively T2, T3), and can be copied and distributed via electronic channel. The memories M1, M2, M3, are for example of the type flash memory, EPROM, EEPROM, removable memory card, CD-ROM, etc. This type of terminal is well known to the person of skill in the art.

The terminal T1 (as well as the other terminals T2, T3) incorporate a processor or microprocessor, one or multiple memory areas and any other components enabling to make it function. In particular, it comprises one or multiple computer programs stored in its memory areas, the aforementioned program(s) comprising instructions that, when executed by the processor, enable carry out of the different steps and/or functions described below. These computer programs (also called programs, computer applications, lines of code, software) can be written in any form of programming language suitable for the person of skill in the art.

The T1 terminal incorporates in particular a computer program whose instructions enable linkage of the acquired file F1 with: a geo-location data l1 and timestamp data t1 (or Time stamping in English). This program also enables connection to the remote server S in order to transfer all this data as it is explained further in the description

According to a preferred implementation mode, this specific computer program can be initially stored in the memory area of the mobile terminal T1 from the design of the latter, or be downloaded later. For example, this program can be downloaded into the mobile terminal after connection of the latter to an Internet server. In particular, it can be downloaded in response to the registration of the user U1 with a community of users. And more generally, the mobile terminal T1, T2, T3 of each member U1 U2, U3 of the community includes this specific computer program.

A function of the geo-location data l1 is to locate the place where the photograph and/or video was acquired. This data l1 can for example comprise GPS coordinates defined using a satellite positioning system and a GPS receiver incorporated into the terminal.

The timestamp data t1 enables linkage of a date and time when the photograph and/or video was acquired. This data t1 can for example comprise a date and time of acquisition defined using a clock incorporated into the terminal T1.

These geo-location l1 and timestamp t1 data comprise digital data that are preferentially automatically linked with the file F1 upon its acquisition. However, it can be planned that this linkage can only be initiated by pressing a specific key of the terminal T1.

The file F1 and linked geo-location l1 and timestamp data t1 are then transmitted to a remote computer server S from the mobile terminal T1. The T1 terminal connects in a conventional manner to the server S, using means of communication such as: Internet, GSM (for the English acronym Global System for Mobile communication), SMS (for the English acronym Short Message Service), MMS (for the English acronym for Multimedia Messaging Service), or any other similar network. The terminal T1 and the server S each incorporate all the material resources, in particular transmission/reception means, and program enabling an exchange of data between them, by radio waves, Wi-Fi, Bluetooth, VPN private channel, or other, which exchange can be secured or unsecured. The transmission of the file F1 and its geo-location l1 and timestamp data t1, can be performed automatically, without user intervention, when the latter acquired the aforementioned file. Alternatively, it is also possible to perform the transmission of file F1 in the same way as a publication of photographs and/or videos on a social network, for example by selecting a function and/or a button “PUBLISH” on the terminal T1.

Complementing the geo-location data l1 and timestamp data t1, other data can be linked with the file F1. Commentary data in particular can be linked with the aforementioned file. The U1 user can for example comment on his photograph and/or video by indicating the conditions of acquisition (ex: “The Eiffel Tower under the snow,” “David Bowie concert at the foot of the Eiffel Tower”, “Marriage of Mary and Paul at the foot of the Eiffel Tower”, etc.). Data enabling identification of the user U1 can additionally be linked with the file F1, in particular a unique identifier that belongs to him. All these additional data are also in the form of digital data.

The remote server S is typically a computer connected to a communications network and incorporating a processor or microprocessor CPU, one or multiple memory areas (for example: Flash memory, EPROM, EEPROM, removable memory card, CD-ROM, . . . ) and any other component enabling it to function. In particular, it comprises one or multiple computer programs stored in one of its memory areas Sm, the aforementioned program(s) comprising instructions that, when executed by the processor CPU, enable performance of various steps and/or functions described below. These computer programs (also called programs, computer applications, lines of code, software) can be written in any form of programming language suitable for the person of skill in the art.

In particular, upon reception of the file F1 and geo-location l1 and timestamp data t1, the remote server S implements a program to create an analysis window FA that determines: a geographic zone ZG and a temporal zone ZT.

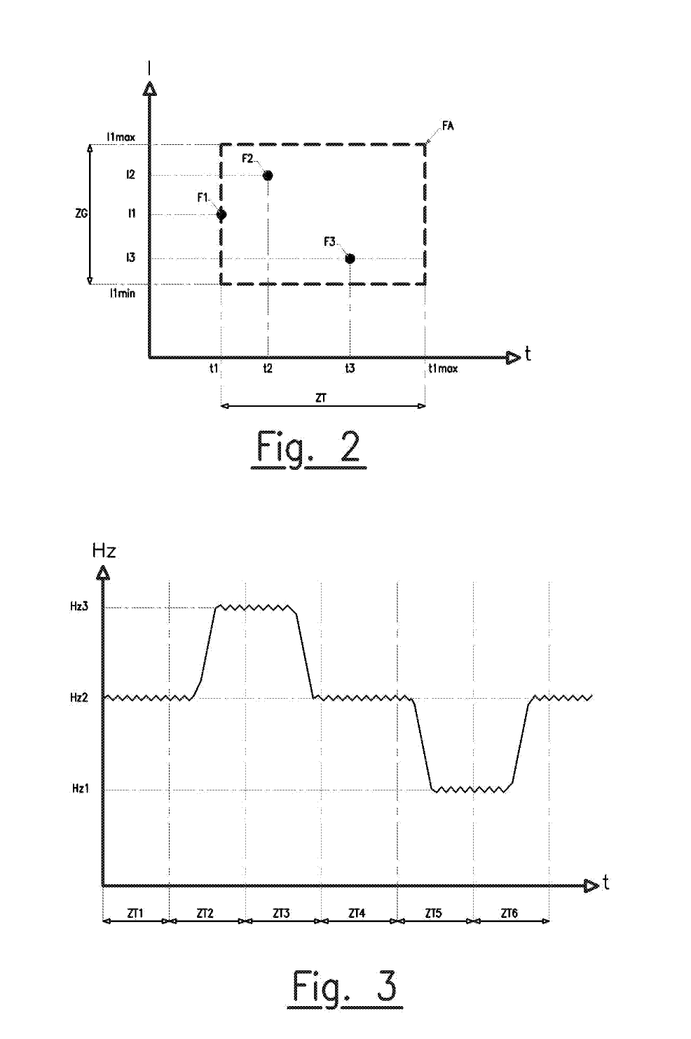

Referring to FIG. 2, the geographic zone ZG is defined around the location where the photograph and/or video was acquired, taking as reference the geo-location data l1. For example, the geographic zone ZG is defined within a radius of 100 m and 10 km around the point l1. On the diagram of FIG. 2, the geographic zone ZG is delimited by the limits l1 min and l1 max around the point l1.

Likewise, the temporal zone ZT is defined based on the time when the photograph and/or video was acquired, taking as reference the timestamp data t1. For example, the temporal ZT area is between 1 min and 24 h based on the instant t1. On the diagram of FIG. 2, the temporal zone ZT is bounded by the limits t1 and t1ₘₐₓ.

The other users U2, U3 acquire other digital files F2, F3 photographs and/or videos, to which are linked geo-location l2, l3 and timestamp t2, t3 data. These other files F2, F3 and linked data, respectively l2, t2 and l3, t3, are then transferred to the remote server S (FIG. 1). These steps are implemented by means of mobile terminals T2, T3, in a manner similar to that described above with reference to the mobile terminal T1.

To automatically report an event, the remote server S will analyze the variation of the frequency of the number of files received by the server within the analysis window FA. The detection of an event is thus based on the concentration of files received by the server S, within the analysis window FA. In other words, the activity of users within the analysis window will be studied. This analysis is preferably carried out by means of an analysis program stored in the remote server S and whose instructions enable implementation of the operations described below.

Referring to the example illustrated in FIG. 2, the remote server S verifies whether the files F2 and F3 must be taken into account or not. For example, for the file F2, if the geo-location datum l2 is included in the segment [l1ₘᵢₙ-1ₘₐₓ] and the time t2 datum is included in the segment [t1-t1ₘₐₓ], then the file F2 will be accounted for. In the opposite case, if does l2 not in [l1ₘᵢₙ-1ₘₐₓ] and/or the temporal datum t2 is not in [t1-t1ₘₐₓ], then the file F2 will be excluded from the analysis. The same verification is imposed on the file F3 and generally on all files received by the remote server S.

In order to refine the analysis of the frequency variation, it can be advantageous to take into account certain habits linked with specific sights or linked with certain users.

For example, the number of files previously sent to the remote server S, from a pre-localized geographic location, and outside the analysis window FA is a parameter taken into account by the analysis program during the identification of a significant variation in the mean frequency. These pre-localized geographic locations are typically tourist sites, sports stadiums, performance halls, etc. In the case of the Eiffel Tower, it has previously entered, in the server 5, that a frequency of approximately 150 photographs/hour is a frequency representative of normal activity, not significative of an event. On the other hand, for a non-touristic geographic location, such a frequency would be representative of an abnormal activity, and therefore significative of an event.

Likewise, the number of files previously sent by a user (for example the user U2) to the remote server S, and outside the analysis window FA can be a parameter taken into account by the analysis program during the identification of a significant variation in the mean frequency. Indeed, if the user U2 has the habit of having a high transfer frequency of files, for example if he has the custom acquiring 50 photographs/hour at each visit to a geographic location, apart from a particular event, the files that he will emit could distort the analysis of the frequency variation of the number of files received by the server S. In fact, the files emitted by the user U2 can: be excluded from the analysis, or be assigned a weighted coefficient. For example, the server S will take into account only one file per group of 50 files received from the user U2. On the other hand, if the habitual normal activity of this user is relatively low, for example, if he has the habit of acquiring 5 photographs/hour at each visit to a geographic location, apart from a particular event, then a frequency of 50 photographs/hour linked with this user would be representative of an abnormal activity, and therefore a significative of an event.

FIG. 3 shows an example of changing the frequency of the number of files received by the server S within the analysis window of FA. More particularly, the diagram shows, for a given geographic zone (for example the Eiffel Tower), an example of variation of the frequency (Hz) of files received by the remote server S as a function of time (t).

In the temporal zone ZT1, the files are received by the server S at a mean frequency Hz2. This frequency is calculated by the server S, for example by means of a probabilities analysis algorithm. Returning to the case of the Eiffel Tower in Paris (France), the server S receives for example normally between 100 photographs/hour and 200 photographs/hour. The mean frequency Hz2 is thus in this case approximately 150 photographs/hour. This mean frequency being typical of a normal activity, no event is detected.

In the temporal zone ZT2, a concert (or a sporting event, for example) takes place at the foot of the Eiffel Tower. The frequency of files received then suddenly increases to reach a frequency Hz3 (with Hz3>Hz2) between for example 1000 photographs/hour and 1500 photographs/hour. This significant increase of the frequency drives the server S to automatically report an event.

According to a preferred implementation mode, the server S identifies a significant variation in the mean frequency Hz2 when the frequency varies from predefined percentage relative to the aforementioned mean frequency. For example when the frequency is higher (or lower) than 100% of the mean frequency Hz2.

Within the temporal zone ZT3, the concert (or sporting event) ends. The frequency of received files then decreases suddenly dropping to come back down the mean normal value Hz2. This significant decrease in the frequency can optionally drive the server S to automatically report the end of the event. In any case, this significant decrease does not cause the server S to report an event, since the frequency returns to normal.

In the temporal zone ZT4, nothing special happens at the foot of the Eiffel Tower. The files are received by the server S at the mean normal frequency Hz2. The server S will not report any event.

Within the temporal zone ZT5, access to the Eiffel Tower is blocked so that tourist cannot access it. The frequency of received files then decreases suddenly to attain a frequency Hz1 (with Hz1<Hz2) between for example 0 photographs/hour and 10 photographs/hour. This significant decrease in the frequency drives the S server to automatically report an event.

Within the temporal zone ZT6, access to the Eiffel Tower is again allowed so that tourists flock back again. The frequency of files received then suddenly increases to reach the mean normal value Hz2. This significant increase in the frequency can optionally drive the server S to automatically report the end of the event but will not cause the server S to report a distinctive new event, since the frequency returns to normal.

When the remote server S detects an event, it can link a signature datum with all the files F1, F2, F3 received within the analysis window FA, after and/or immediately prior to such event. For example, descriptive digital data, such as corresponding to the term “EVENT”, can be linked with each of these files. Referring to the example shown in FIG. 3, all files received within the temporal zone ZT2 and within temporal zone ZT5 are linked with a signature datum. All these marked files can subsequently be grouped together in an area of the remote server S, for example in the memory area Sm.

According to an advantageous feature of the invention enabling users U1, U2, U3 to be notified of an event, the remote server S generates a notification signal Sa and, as shown in FIG. 1, transmits it to all the mobile terminals T1, T2, T3 from which are emitted the files F1, F2, F3 received within the analysis window FA. More generally, this notification signal Sa can be transmitted to all members of the community having downloaded in their mobile terminal, the specific computer program cited above. In this way, even the members of the community who did not actively participate in the signaling of an event (in particular those who are not at the place of the event, and/or those not having acquired or transferred to the server S, a photograph and/or video file), are notified of this event. The notification signal Sa can, manifest itself in the form of an audible or visual message, of to an email, of an SMS, of an MMS, of a selectable link, or in any other similar form.

The signaling of an event can comprise an alternative or complementary step of generating, from the remote server S, a web page Pi dedicated to the event (FIG. 1). This web page Pi is accessible to all users and/or to all members of the community. It can be viewable directly from a screen of the terminals T1, T2, T3, or from any other computer terminal screen. The screen can be of the plasma screen, LCD screen type, etc. The users U1, U2, U3 can access this page by selecting a selectable link transmitted by the server S, the link of which corresponds to the notification signal Sa, or by connecting to the web server dedicated to the user community. This server can be the remote server S or another server interconnected to the aforementioned remote server.

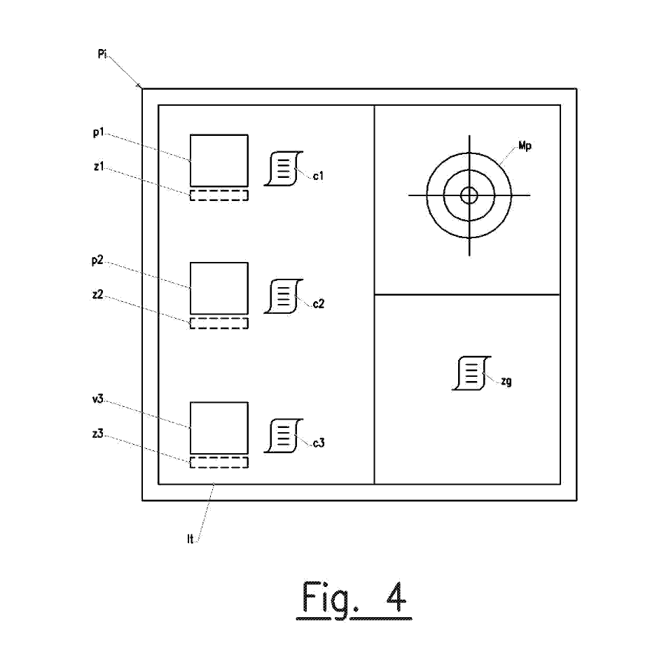

Referring to FIG. 4, the web page Pi comprises an interface lt on which are viewable all the photographs p1, p2 and/or videos v3 from files F1, F2, F3 received within the analysis window FA during the event. A map Mp enabling precise localization of the event can also be displayed in a specific region of the interface lt. The commentaries c1, c2, c3, linked with the photographs p1, p2 and/or videos v3 and that are transmitted at the same time as the other geo-location and temporal data of the files, can also be viewed.

The interface lt can also include an area zg enabling users U1, U2, U3 or other members of the community to rate and/or comment on the event. They can, in particular, confirm that it is in fact an event or to the contrary rule it out invalidate it One or multiple other areas z1, z2, z3 are again envisaged in order to comment on the photographs and/or videos that are viewable. This is in practice areas and accessible and selectable using a pointer, a mouse or a touchpad, and where each user can write a comment by using a keyboard or a voice command. Each comment can be optionally be previously controlled, by a moderator body, before being published on the web page Pi.

The arrangement of the various elements of the system in the implementation modes described above should not be understood as requiring such an arrangement in all implementations. In any case, it will be understood that various modifications can be made to the system and method without departing from the spirit and scope of the invention.

1. A method for automatically reporting an event based on files received on a computer server, the aforementioned method comprising:
acquiring, in digital file form, a photograph and/or video from a mobile device,
linking the acquired file with:
a geo-location datum in order to locate the place where the photograph and/or video was acquired,
a timestamp datum in order to link a date and time when the aforementioned photograph and/or the aforementioned video was acquired,
transferring the file and the linked geo-location and timestamp data to a remote computer server of the mobile terminal,
characterized in that the aforementioned method further comprises the steps comprising:
creating, in the remote server, an analysis window that determines:
a geographic zone defined around the place where the photograph and/or video was acquired, the aforementioned geographic zone defined by taking the geo-location data as reference,
a temporal zone defined based on the time the photograph and/or video was acquired, the aforementioned temporal zone being defined by taking the timestamp datum as reference,
acquiring other photograph and/or video digital files and linking them with geo-location and timestamp data, then transferring these files and this data to the remote server,
analyzing the variation of the frequency of the number of files received by the remote server within the analysis window, in order to automatically report an event.

2. A method according to claim 1, wherein the analysis of the variation of the frequency of the number of files received by the remote server within the analysis window, comprises the following succession of steps:
determination of a mean frequency of the files received within the analysis window,
identification of a significant variation in the mean frequency when the frequency of the files received within the analysis window varies from a predetermined percentage relative to the aforementioned mean frequency.

3. A method according to claim 2, wherein the number of files previously sent by a user, to the remote server, and outside of the analysis window, is a parameter taken into account for the identification of a significant variation from the mean frequency.

4. Method according to claim 2, wherein the number of files previously sent by a user to the remote server, from a pre-localized geographic location, and outside the analysis window, is a parameter taken into account for the identification of a significant change from the mean frequency.

5. A method according to claim 4, comprising discarding from the analysis files sent by a user who has a habit of having a high file transfer frequency.

6. A method according to claim 4, comprising assigning a weighting coefficient to the files emitted by a user who has a habit of having a high file transfer frequency.

7. A method according to claim 1, wherein the step of automatic reporting of an event comprises a step comprising linking a signature datum with all the files received within the analysis window, after and/or immediately before this event.

8. A method according to claim 7 wherein the step of automatic reporting of an event comprises a step comprising grouping, in an area of the remote server, all the files that are linked with the signature datum.

9. A method according to claim 1, wherein the step of automatic reporting of an event comprises a notification step comprising generating, from the remote server, a notification signal and transmitting this signal to all the mobile terminals from which the files, received within the analysis window, are emitted.

10. A method according to claim 1, wherein the step of transferring files and linked geo-location and timestamp data, to the remote server, is performed by means of a mobile computer program stored in the mobile terminals, wherein the program is downloaded to the aforementioned terminals further to a connection of the latter to an Internet server.

11. A method according to claim 10, wherein the step of automatic reporting of an event comprises a step of generating, from the remote server, a notification signal and transmitting this signal to all the mobile terminals in which are stored in the aforementioned computer program.

12. A method according to claim 1, wherein the step of automatic reporting of an event comprises a notification step comprising generating, from the remote server, a web page dedicated to the event, which page comprises an interface on which are viewable all the photographs and/or videos from the files received within the analysis window, during the event.

13. A method according to claim 12, wherein the interface of the web page dedicated to the event comprises an area enabling rating or commentary the aforementioned event and/or one or multiple areas enabling rating or commentary of each viewable photograph and/or video.

14. A method according to claim 1, wherein complementing the geo-location data and timestamp data linked with the photograph and/or video files, commentary data are linked with the aforementioned files.

15. A system to automatically report an event based on files received on a computer server, the aforementioned system comprising:
mobile devices incorporating:
a means for acquiring, in digital file form, a photograph and/or a video,
a computer program comprising instructions to generate a geo-location datum in order to locate the place where the photograph and/or video was acquired, and to generate a timestamp datum in order to link a date and time when the aforementioned photograph and/or the aforementioned video was acquired,
a means for transferring the photograph and/or video file and the linked geo-location and timestamp data to a remote computer server of the mobile terminals,
the remote server incorporating a computer program comprising instructions for:
creating an analysis window that depends:
on a geographic zone defined around the place where the first photograph and/or video was acquired, the aforementioned geographic zone being defined by taking as reference the geo-location datum linked with the aforementioned first photograph and/or video,
on a temporal zone defined based on the moment when the first photograph and/or video was acquired, the aforementioned temporal zone being defined by taking as reference the timestamp data linked with the aforementioned first photograph and/or video,
analyzing the variation of the frequency of the number of files received by the remote server within the analysis window, in order to automatically report an event.
